(19) United States
(12) Patent Application Publication
(10) Pub. No.: US 2014/0323095 A1
(43) Pub. Date: Oct. 30, 2014

(54) METHOD AND DEVICE FOR MONITORING A MOBILE RADIO INTERFACE ON MOBILE TERMINALS

(71) Applicants: Steffen Liebergeld, Dresden (DE); Matthias Lange, Dresden (DE); Collin Mulliner, Boston, MA (US)

(72) Inventors: Steffen Liebergeld, Dresden (DE); Matthias Lange, Dresden (DE); Collin Mulliner, Boston, MA (US)

(73) Assignee: Deutsche Telekom AG, Bonn (DE)

(21) Appl. No.: 14/351,165

(22) PCT Filed: Sep. 5, 2012
(86) PCT No.: PCT/EP2012/067341

§ 371 Date: May 20, 2014

(30) Foreign Application Priority Data
Oct. 14, 2011 (DE) 10 2011 054 509.3

(51) Int. Cl. H04W 12/08

(52) U.S. Cl. CPC H04W 12/08
USPC 455/411

(57) ABSTRACT

A method for monitoring a mobile radio interface on a mobile terminal, the mobile terminal having a baseband and an application processor, includes: executing an operating system on the application processor; and executing a virtual modem on the application processor, which exclusively performs the data exchange between the operating system and the baseband and provides the functionality of the baseband in order thereby to gain access to data and in order thereby to filter out unauthorized data.

### CROSS-REFERENCE TO PRIOR APPLICATIONS

This application is a U.S. National Phase application under 35 U.S.C. §371 of International Application No. PCT/EP2012/067341, filed on Sep. 5, 2012, and claims benefit to German Patent Application No. DE 10 2011 054 509.3, filed on Oct. 14, 2011. The International Application was published in German on Apr. 18, 2013 as WO 2013/053550 under PCT Article 21(2).

### FIELD

The invention relates to a method and a device for monitoring a mobile radio interface on mobile terminals, in particular a virtual modem for monitoring AT accesses.

### BACKGROUND

In recent years, much has been done to make smartphone operating systems more secure. In this context, the object is to protect the user from attacks and malware (Trojans, computer viruses). Examples of such measures include
mandatory access control (MAC) in order to be able to restrict and monitor access to sensitive resources (for example location data, SMS database, address book)
data caging
address space layout randomization (ASLR) in order to make it harder to exploit security gaps.

Despite known attacks on mobile radio networks by hijacked mobile telephones, to date, hardly any methods for the protection of the infrastructure of mobile radio networks are known. To date, mobile radio network operators only have the option of installing an SMS filter in their networks in order to be able to filter out unwanted SMS messages. Instead, these attacks have demonstrated that current security measures are aimed at the protection of the device against attacks and to a lesser degree of the environment (mobile radio network) in which they work.

U.S. Pat. No. 5,628,030 describes a virtual modem as a device which provides a communication channel to a plurality of simultaneously active communication applications. The virtual modem then selectively connects the communication application to the physical modem. The virtual modem implements an abstract modem interface.

In contrast to this, the present invention does not disclose a method for multiplexing a physical modem; instead it discloses a method with which the access of a mobile terminal to a mobile radio network on the mobile terminal can be monitored in a secure manner. Moreover, U.S. Pat. No. 5,628,030 only relates to desktop computers.

DE 000069925732 T2 describes a mobile telephone with built-in security firmware. This describes a method which enables secure access to an intranet via unprotected networks. In this case, the security layer is implemented on the mobile telephone in the form of firmware or an external hardware module.

On the other hand, the present invention does not require protected firmware or an external hardware module. In addition, it does not describe a method for protecting communication relationships.

Signalling messages are generated by the mobile telephone and usually sent to the mobile switching centre (MSC) and home location register (HLR). In the case of data connections, the serving GPRS support node (SGSN) and the gateway GPRS support node (GGSN) are also involved.

In a mobile radio network, data are sent via the so-called packet data protocol (PDP). The establishment of PDP connections is a complex process. The mobile terminal first sends a “GPRS-attach” message to the SGSN. The SGSN authenticates the mobile terminal with the aid of the HLR. Following this, a PDP context is generated and stored in the SGSN and GGSN. The PDP context is used inter alia to store information on accounting, quality of service and the IP address of this connection. The administration and switching of a PDP context via the different components of a mobile radio network is very complicated.

The connection of a mobile terminal to the mobile radio network takes place via a component, the so-called baseband, which can be made up of a plurality of individual components, such as, for example baseband processors, radio modules, software etc. This baseband usually contains a standard processor, a digital signal processor (DSP) and the radio components required for the radio connection. Before they can be used in the mobile radio network, the baseband and its components, such as the baseband processor and the software thereon, have to be certified and authorised by different institutions. This process is complicated and cost-intensive. This why there are only very few baseband manufacturers in the world.

Usually, in addition to the baseband, mobile terminals also contain a so-called application processor. In the case of mobile telephones, the telephone operating system (for example iOS or Android) runs on the application processor. In the case of so-called UMTS sticks, the application processor is the computer's processor. In each case, the baseband and application processor are only connected to each other at a few places, inter alia via a control channel. The application processor communicates via this control channel with the aid of control commands in order to control the baseband.

### SUMMARY

In an embodiment, the present invention provides a method for monitoring a mobile radio interface on a mobile terminal The mobile terminal includes a baseband and an application processor. The method includes: executing an operating system on the application processor; and executing a virtual modem on the application processor, which exclusively performs the data exchange between the operating system and the baseband and provides the functionality of the baseband in order thereby to gain access to data and in order thereby to filter out unauthorized data.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 shows the concept and layer structure of the virtual modem;

FIG. 2 shows a flow chart of the basic method of the control command filter.

### DETAILED DESCRIPTION

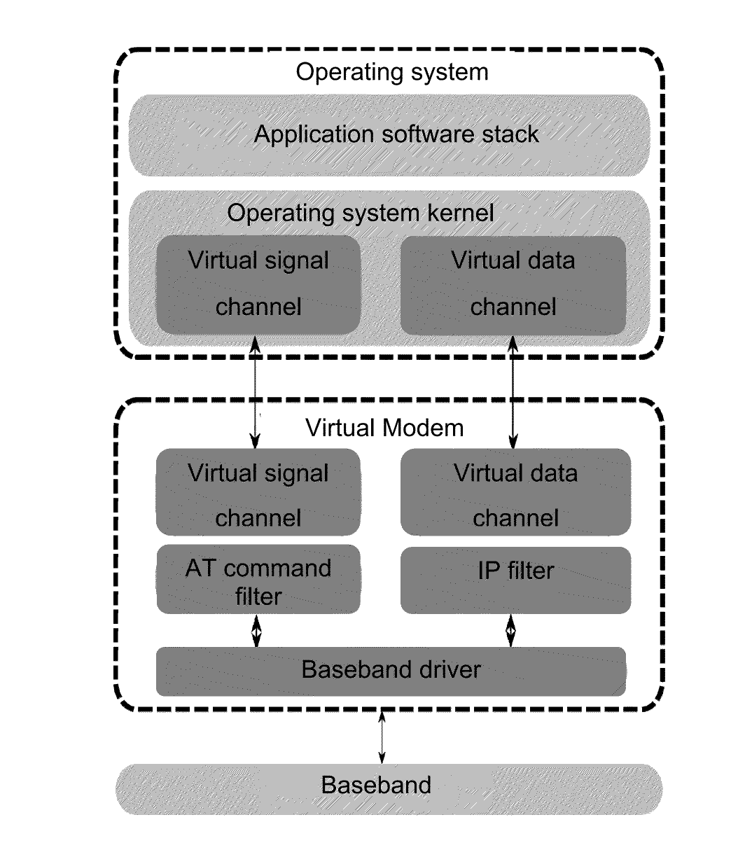

The present invention (hereinafter the virtual modem) for monitoring the signalling channel of a mobile terminal does not require any changes to the baseband hardware or software. The virtual modem runs completely on the application processor and has exclusive control over the baseband. The existing operating system on the application processor can no longer access the baseband directly. Instead, the virtual modem offers the operating system an interface to the baseband and can hence monitor all accesses to the baseband. FIG. 1 is a depiction of this architecture. The interface preferably comprises two channels, although it will be appreciated that the interface may include further channels as well. In one embodiment, one of the channels is used for the control command flow, the second for the data flow.

In detail, the invention relates to a method for monitoring a mobile radio interface on a mobile terminal, which comprises a baseband and an application processor. The method comprises the steps:
execution of an operating system on the application processor. In this case, inter-applications, such as internet browsers or a camera are executed on the application processor.

As a further step, the method comprises the execution of a virtual modem on the application processor, which exclusively performs the data exchange between the operating system and the baseband and provides the functionality of the baseband in order thereby to gain access data and thereby to filter out unauthorised data and accesses.

In a preferred form, the virtual modem provides a virtual signal channel and a virtual data channel, wherein control commands, which control the virtual modem, are preferably transmitted via the virtual signal channel. Moreover, in addition to other data, IP data are also transmitted via the data channel. It is also possible for voice data to be transmitted as Voice over IP, which are transmitted as IP data.

In the preferred embodiment, a control command filter is a component of the virtual modem, which monitors the control command flow between the operating system and the baseband and filters it according to specifications.

An IP filter can also be a component of the virtual modem in order to block unwanted accesses from the exterior or interior by means of the implementation of a firewall.

The virtual modem provides a baseband in the form of an abstract modem interface in which the functionality and the interfaces of the baseband are provided. Hence, no, or only a few, changes to the operating system and the hardware are required. This is preferably a software solution. Alternatively, a combination of hardware and software may be provided.

The virtual modem also comprises a baseband driver, which provides an interface to the baseband. This driver has a similar or identical structure to that of the driver of the operating system, which normally accesses the baseband directly. Hence, this driver establishes a connection to the baseband driver of the operating system.

One central component of the virtual modem is the control command filter. This monitors and filters the control command flow between the operating system and the baseband. Hereby, the security guidelines for the signalling channel with respect to the baseband are enforced.

The IP filter component implements a firewall, which, for example, blocks unwanted accesses from the exterior or interior. It monitors the data traffic passing through it and decides on the basis of defined rules whether or not certain network packets will be let through. In this way, it attempts to block unauthorised network accesses. The firewall can work at protocol level, at port level, and/or at content level, and it can identify attacks with certain patterns (for example DoS) and provide stateful inspection. It may also perform intrusion detection and prevention functions.

From the viewpoint of the operating system, the virtual modem behaves like a “real” baseband. There is no need to change the existing operating system. All that is needed is the usual adaptation for the integration of a new baseband.

The present invention, which uses a virtual modem, can, for example, be used for the following applications:
premium SMS filters
premium number filters
protecting the mobile radio infrastructure against signalling channel-based DoS attacks
suppression of mobile botnets
updating the access guidelines for remote maintenance (remote update)
user-defined specialisation/updating access guidelines for so-called premium services
unavoidable VPN access
firewall on the mobile terminal

The virtual modem offers the improvements relative to the prior art, including:
no or only a few modifications to the existing operating system required, depending upon the implementation;
no modifications to the existing mobile hardware required;
protection of the mobile radio network against hijacked mobile terminals;
filtering of the signalling measures directly on the mobile terminal so that overloading of the mobile radio network infrastructure is avoided;
more cost-effective usage, because the virtual modem is implemented directly on the mobile terminal, no changes to the infrastructure are required;
blocking of expensive value-added services (so-called premium SMS or premium numbers)
monitoring of data access.

Hence, the invention facilitates
successful blocking of an SMS Trojan
heuristic recognition of command-and-control-channels via SMS
DoS attacks on the mobile radio network operator's infrastructure are more complicated (increase in subscribers by at least 700%)
reduction of the load on the mobile radio infrastructure by the rate limitation of critical commands

FIG. 1 shows the layer structure of a mobile terminal of the present invention. The operating system runs on an application processor, that is as a rule, real hardware, but in individual cases, it can also be virtualized.

In the case of virtualization, the operating system, for example Android, runs on a virtualization layer, also known as a hypervisor, wherein the virtual modem is arranged either in the hypervisor as virtual hardware or even a virtual machine, which runs on the hypervisor. The operating system comprises an application software stack, on which applications for the user run. This stack can, for example, comprise libraries and frameworks which are used by the applications. It also offers interfaces to the operating system kernel. Inside this kernel, there are a virtual signal channel and a virtual data channel to a virtual modem, which is switched as an intermediate layer between the baseband and the operating system. Hence, the operating system only has access to the baseband via the virtual modem. The virtual signal channel is as a rule used to send control commands which have the task of controlling the virtual modem. When the modem has been set, the data is then transmitted via the virtual data channel, for example as a data flow. The data flow can comprise a flow of conversation, but also internet data (IP data). Then, filters will be applied to the respective data flow (AT command filters and IP Filter) in order to filter out unauthorized or unwanted data in both directions. The filters are adjustable and based on rules or patterns regarding which data are to be filtered out. For example, scanners, which recognize a malware content, or even other content filters, such as protocol filters, can be applied to the IP filter. Arranged within the virtual modem is a baseband driver, which, if necessary, combines the two flows and forwards them to the baseband/unit, as described above. However, alternatively, the data can also be forwarded via two separate channels.

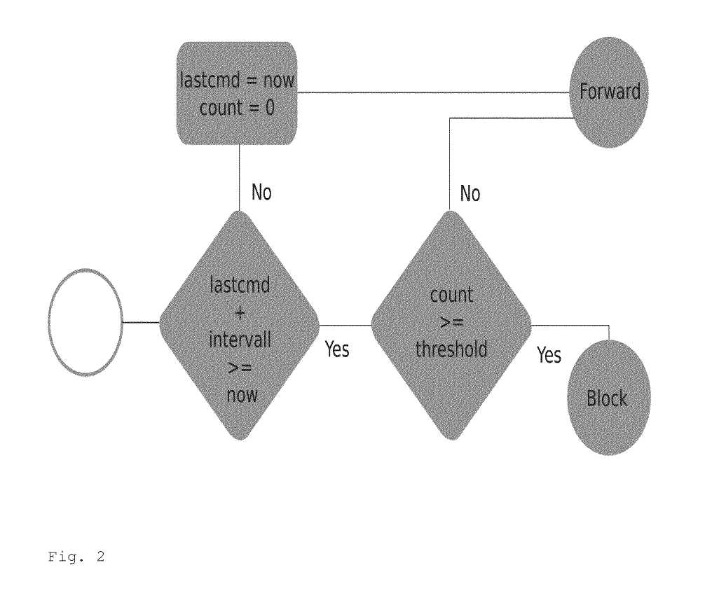

FIG. 2 shows an example of an application of the present invention.

In this case, certain attacks are recognized and filtered out.

Call-forwarding attack:
Many compromised mobile telephones continually change the call forwarding settings and hence give rise to a significant load in the infrastructure of the mobile radio network supplier.
The application software generates a command to change the call forwarding settings. This command is transmitted via the virtual signal channel to the virtual modem. The control command filter checks with reference to an adjustable threshold whether the authorized number of commands/time unit for this function has been exceeded and, if applicable, blocks the command until the start of the next time interval. If the authorized number has not yet been exceeded, the command is forwarded to the baseband driver and finally sent from the baseband to the mobile radio network. FIG. 2 shows that, if the time of the last command plus an interval is greater than the current time point, a counter is checked; if the counter is above a threshold value, the message is blocked. Otherwise, the message is forwarded.
Premium SMS messages:
SMS Trojans send expensive premium SMS messages without the knowledge of the user and hence can result in significant financial damage to the user.
The SMS Trojan transmits an SMS to a premium number via the virtual signal channel. The control command filter checks with reference to a blacklist/whitelist whether the SMS should be sent. If the recipient's number is contained in a blacklist, a suitable warning can be shown and, optionally, confirmation of the user can be demanded. If the user rejects the transmission, the SMS message will be discarded. These lists, can, for example, be updated regularly online.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1-12. (canceled)

13. A method for monitoring a mobile radio interface on a mobile terminal, the mobile terminal comprises a baseband and an application processor, the method comprising:
executing an operating system on the application processor; and
executing a virtual modem on the application processor, which performs all data exchange between the operating system and the baseband and provides the functionality of the baseband in order thereby to gain access to data and in order thereby to filter out unauthorized data.

14. The method according to claim 13, wherein the virtual modem provides a virtual signalling channel and a virtual data channel.

15. The method according to claim 14, wherein control commands are transmitted via the virtual signalling channel, which control the virtual modem, and Internet Protocol (IP) data are transmitted via the data channel.

16. The method according to claim 15, wherein a control command filter is a component of the virtual modem, and the control command filter monitors the control command flow between the operating system and the baseband and filters it according to specifications.

17. The method according to claim 16, wherein one or more of the following components are used in the control command filter in order to filter the data:
number filters;
filters to protect the mobile radio infrastructure from signalling channel-based DoS attacks;
filters to suppress mobile botnets;
updating components for the access guidelines, which are subject o regular updates;
component for user-defined specialization/updating of access guidelines for so-called premium services; and
control components to restrict VPN accesses.

18. The method according to claim 15, wherein an IP filter is a component of the virtual modem in order to block unwanted accesses from the exterior or interior by means of the implementation of a firewall.

19. The method according to claim 18, wherein one or more of the following components are used in the IP filter in order to filter the data:
number filters;
filters to protect the mobile radio infrastructure from signalling channel-based DoS attacks;
filters to suppress mobile botnets;
updating components for the access guidelines, which are subject to regular updates;
component for user-defined specialization/updating of access guidelines for so-called premium services; and
control components to restrict VPN accesses.

20. The method according to claim 13, wherein the virtual modem implements a baseband, in which the functionality and the interfaces of the baseband are provided.

21. The method according to claim 20, wherein the virtual modem comprises a baseband driver, which provides an interface to the baseband.

22. A mobile terminal with a mobile radio interface, the mobile terminal comprising:
a baseband and an application processor, wherein the application processor is configured to execute an operating system;
wherein the application processor is further configured to implement a virtual modern which performs all data exchange between the operating system and the baseband and provides the functionality of the baseband in order thereby to gain access to data and in order thereby to filter out unauthorized data.

23. The mobile terminal according to claim 22, wherein the virtual modem provides a virtual signal channel and a virtual data channel.

24. The mobile terminal according to claim 23, wherein control commands, which control the virtual modem, can be received via the virtual signalling channel and Internet Protocol (IP) data can be transmitted via the data channel.

25. The mobile terminal according to claim 24, wherein a control command filter is a component of the virtual modem, which monitors the control command flow between the operating system and baseband and filters it according to specifications.

26. The mobile terminal according to claim 25, wherein one or more of the following components are used in the control filter in order to filter the data
number filters;
filters to protect the mobile radio infrastructure from signalling channel-based DoS attacks;
filters to suppress mobile botnets;
updating components for the access guidelines, which are subject to regular updates;
component for user-defined specialization/updating of access guidelines for so-called premium services; and
control components to restrict VPN accesses.

27. The mobile terminal according to claim 24, wherein an IP filter is a component of the virtual modem in order to block unwanted accesses from the exterior or interior by means of the implementation of a firewall.

28. The mobile terminal according to claim 27, wherein one or more of the following components are used in the IP filter in order to filter the data
number filters;
filters to protect the mobile radio infrastructure from signalling channel-based DoS attacks;
filters to suppress mobile botnets;
updating components for the access guidelines, which are subject to regular updates;
component for user-defined specialization/updating of access guidelines for so-called premium services; and
control components to restrict VPN accesses.

29. The mobile terminal according to claim 22, wherein the virtual modem is configured to emulate a baseband in which the functionality and the interfaces of the baseband are provided.

30. The mobile terminal according to claim 29, wherein the virtual modem comprises a baseband driver which provides an interface to the baseband.
